(19) United States
(12) Patent Application Publication
(10) Pub. No.: US 2025/0165816 A1
(43) Pub. Date: May 22, 2025

(54) STORING AND OBTAINING ATTRIBUTE DATA OF ATTRIBUTES OF MACHINE LEARNING MODELS

(71) Applicant: Microchip Technology Incorporated, Chandler, AZ (US)

(72) Inventors: Chris NORRIE, Castro Valley, CA (US); Igor ZIPER, Sunnyvale, CA (US); Pitamber SHUKLA, San Jose, CA (US)

(21) Appl. No.: 18/747,429

(22) Filed: Jun. 18, 2024

Related U.S. Application Data
(60) Provisional application No. 63/600,032, filed on Nov. 16, 2023.

(51) Int. Cl. G06N 5/04

(52) U.S. Cl. CPC G06N 5/04

(57) ABSTRACT

In some implementations, a controller may receive a request for an inference. The controller may determine, based on the received request for the inference, a first inference model of a plurality of inference models, to generate the inference. The controller may obtain, from a memory associated with an inference cache, first attribute data regarding first attributes of the first inference model. A location of the first attribute data, in the memory, may be determined using the inference cache. The attributes may include weights associated with the first inference model, biases associated with the first inference model, and a structure of the first inference model. The controller may utilize the first attribute data to generate the inference based on the request.

### RELATED APPLICATION

This application claims priority to U.S. Provisional Patent Application No. 63/600,032 entitled “A CACHING APPARATUS AND METHOD FOR MACHINE-LEARNING TRAINING-DATA DURING INFERENCES,” filed Nov. 16, 2023, which is incorporated herein by reference in its entirety.

### FIELD

The present disclosure generally relates to attributes of different machine learning models and, for example, relates to storing attribute data of the attributes in a cache.

### BACKGROUND

A machine learning model may include a computer program that may recognize patterns in data sets. Based on recognizing the patterns, the machine learning model may make inferences or make predictions. The machine learning model may be trained using training data. For example, the trained data may be used to train a machine learning algorithm used by the machine learning model. The training data may include labeled data, unlabeled data, or a combination of labeled data and unlabeled data.

### SUMMARY

In some implementations, a method comprising: receiving a request for an inference; determining, based on the received request for the inference, a first inference model of a plurality of inference models, to generate the inference, obtaining, from a memory associated with an inference cache, first attribute data regarding first attributes of the first inference model, wherein a location of the first attribute data, in the memory, is determined using the inference cache, and wherein the attributes include weights associated with the first inference model, biases associated with the first inference model, and a structure of the first inference model; and utilizing the first attribute data to generate the inference based on the request.

In some implementations, a system comprising: an inference cache; a memory associated with the inference cache; and a controller, associated with the inference cache, the controller to: store first attribute data, regarding first attributes of a first machine learning model, in the memory, wherein the first machine learning model is a first trained machine learning model; store second attribute data, regarding second attributes of a second machine learning model, in the memory, wherein the second machine learning model is a second trained machine learning model; obtain, from the memory, one of the first attribute data or the second attribute data based on a request to generate an inference, wherein a location of the one of the first attribute data or the second attribute data, in the memory, is determined using the inference cache; and utilize the one of the first attribute data or the second attribute data to generate the inference.

In some implementations, a computer program product comprising: one or more computer readable storage media, and program instructions collectively stored on the one or more computer readable storage media, the program instructions comprising: program instructions to store addresses of first attribute data, regarding first attributes of a first trained machine learning model, in an inference cache; program instructions to store addresses of second attribute data, regarding second attributes of a second trained machine learning model, in the inference cache; and program instructions to obtain, from a memory associated with the inference cache, one of the first attribute data or the second attribute data based on a request to generate an inference, wherein the one of the first attribute data or the second attribute data is obtained using the addresses of the first attribute data or the addresses of the second attribute data.

### BRIEF DESCRIPTION OF THE DRAWINGS

FIGS. 1A-1G are diagrams of an example associated with caching attribute data of attributes of trained machine learning models.

FIG. 2 is a diagram of example components of one or more devices of FIG. 1.

FIGS. 3A-3C are flowcharts of an example process relating to caching attribute data of attributes of trained machine learning models.

FIG. 4 is a flowchart of an example process relating to caching attribute data of attributes of trained machine learning models.

FIG. 5 is a flowchart of an example process relating to caching attribute data of attributes of trained machine learning models.

### DETAILED DESCRIPTION OF PREFERRED EMBODIMENTS

The following detailed description of example implementations refers to the accompanying drawings. The same reference numbers in different drawings may identify the same or similar elements.

A machine learning model may be trained using training data. For example, a machine learning algorithm may be trained using the training data, resulting in a trained machine learning model. The trained machine learning model may be used to make inferences based on new data (e.g., data that is different than the trained data). As used herein, an “inference” may refer to a classification, a regression, an anomaly detection, or clustering, without limitation. Additionally, an “inference” may be used to refer to a prediction (e.g., forecasting or estimating an outcome).

The trained machine learning model may be defined by attributes, such as parameters, an architecture or structure, and the trained machine learning model may include an activation function, among other examples. The parameters may include variables that are used to decrease a difference between an inference and an actual target value. The parameters may include weights and biases. The architecture or structure may refer to a number of layers along with an arrangement of layers, nodes, and connections of the trained machine learning model. The attributes may define a behavior, capabilities, and a performance of the trained machine learning model. Attribute data regarding the attributes may be used to make inferences.

In applications that utilize trained machine learning models, an inference request may utilize one of multiple sets of attribute data. An inference engine may include an implementation of a trained machine learning model that performs (or generates) the inference using attribute data. If the attribute data is already resident in the inference engine, the inference may be performed without reloading the attribute data. However, if the attribute data is not stored in the inference engine, the attribute data may be loaded in the inference engine.

Loading the attribute data is a time-consuming operation (when compared to an amount of time for performing the inference). For example, if the attribute data comprises 8K of 32-bit floating-point numbers, which are loaded at 128 bits per clock cycle, at least 2048 clock cycles may be used to load the attribute data. This number of clock cycles may be significant or even commensurate with respect to the time to perform an inference. In this regard, the loading of attribute data may reduce (e.g., by a half) the rate at which inferences can be performed.

In some situations, loading the attribute data will cause previously loaded attribute data (previously loaded in the inference engine) to be displaced. If the displaced attribute data is to be used to perform a subsequent inference, the displaced attribute data will have to be reloaded in the inference engine prior to performing the subsequent inference. Similarly with respect to loading attribute data as explained herein, the performance cost of reloading the additional attribute data may be a time-consuming operation. Accordingly, a need exists to perform inferences in a timely manner (e.g., without being subjected to the delays described above).

Implementations described herein are directed to using an inference cache (or a cache) to store attribute data of attributes of trained machine learning models. The attribute data may be provided to an inference engine to perform inferences using the attributes of the trained machine learning models. As indicated above, attributes of a trained machine learning model may include weights and biases of the trained machine learning model, an architecture or structure of the trained machine learning model, a machine learning algorithm of the trained machine learning model, or an activation function of the trained machine learning model, among other examples.

The inference engine may apply logical rules (e.g., associated with attribute data of the trained machine learning model) to an input and generate an output. In some examples, the inference engine may be included on a controller (e.g., a central processing unit (CPU) or a graphics processing unit (GPU)). In some implementations, the inference engine may include a vector processor. In some examples, first attribute data of attributes of a trained first machine learning model may be loaded into the inference engine (e.g., into the vector processor) to enable the inference engine to perform a first inference, the first attributed data may be removed and second attribute data of attributes of a trained second machine learning model may be loaded into the inference engine (e.g., into the vector processor) to enable the inference engine to perform a second inference, and so on.

The trained machine learning models may be trained using different training data and may generate different types of inferences. In this regard, the inference engine may perform different types of inferences using different trained machine learning models as opposed to performing a same type of inference using a single trained machine learning model.

In some implementations, the inference cache may store the attribute data of the attributes of the trained machine learning models. The attribute data may also be stored on a memory (e.g., a main memory) of the controller. The inference cache may be used to provide the attribute data to the inference engine at a speed that exceeds the speed at which the attribute data may be provided to the inference engine from the main memory. The inference cache may store the attribute data for one or more trained machine learning models that are frequently used by the inference engine. In some implementations, the inference cache may include a static random-access memory (SRAM) and the main memory may include a dynamic (DRAM). The cached attribute data may be directly accessed by the inference engine.

In some implementations, the inference cache may be divided into allocatable units referred to as “cache sets” (or referred to as sets). In some situations, a cache set may be allocated such that a size of a cache set is large enough to accommodate a size of typical attribute data of a trained machine learning model. In some implementations, the cache sets may identify ranges of addresses of a same size. The size may be determined by the controller based on sizes of attribute data of multiple trained machine learning models.

In some situations, a size of attribute data of attributes of a trained machine learning model may exceed a size of a single cache set. Accordingly, unlike a typical cache set, the attribute data may be stored in multiple cache sets of the inference cache described herein. The multiple cache sets may be contiguous cache sets (e.g., cache set 0 and cache set 1 in contiguous sections of the inference cache). In some situations, while the multiple cache sets may be contiguous cache sets, the attribute data may be obtained from non-contiguous locations in the memory.

The inference cache described herein may track attribute data of multiple trained machine learning models loaded into the inference engine and may avoid unnecessary re-fetching of the attribute data. For example, the inference cache may track which cache sets have been assigned to respective attribute data of the multiple trained machine learning models. For instance, a first cache set, of the inference cache, may indicate that attribute data (of the first trained machine learning model) has been loaded into in a memory space identified by the first cache set. The memory space may include a memory of the inference engine (e.g., an SRAM of the vector processor). The memory of the inference engine may operate as a data array of the inference cache. The memory may be directly accessed by the vector processor. In this regard, when a cache hit occurs then the attribute data need not be moved into the vector processor because the attribute data is already in the memory directly accessed by the vector processor. The cache sets may operate as a tag array of the inference cache and may indicate ranges of addresses of the memory where the attribute data is stored. The cache sets may indicate a location, in the memory, where the attribute data starts. Accordingly, the cache sets may provide information to the vector processor so that the vector processor may fetch correct weights and biases for a trained machine learning model (e.g., an inference model) being requested by the inference engine to perform an inference. The cache sets may provide an offset to an actual address in the memory of the attribute data. As an example, if a cache hit occurs and the attribute data starts at 0x1234 and an inference layer (of the inference engine) typically uses data starting at address 0x100, then the address of the attribute data may be translated to 0x1334 (or 0x100+0x1234). In this way, trained machine learning models may behave as if they were a single trained machine learning model with attribute data starting at a same address (e.g., address 0).

The inference cache described herein may enable the attribute data (of the multiple trained machine learning models) to be dynamically swapped out in a manner that reduces the number of times the attribute data is to be re-loaded in the vector processor. Furthermore, the inference cache described herein automatically allows for the substitution of any attribute data. In this regard, the inference cache described herein may enable the inference engine to access attribute data of the multiple trained machine learning models in a more efficient manner and a more expedited manner (as compared to existing methods of accessing attribute data of trained machine learning models).

With respect to swapping attribute data, a replacement algorithm may be used to track one or more cache sets that are to be evicted when a cache miss occurs, i.e. when the attribute data required by a present inference request is not found in the cache set. As an example, a least recently used (LRU) algorithm may be used to track a cache set that is to be evicted (if weights and biases, requested for the inference, are not already in a memory associated with the inference cache (e.g., a RAM) and need to be loaded from an external memory). The LRU algorithm described herein (also referred to as a modified LRU algorithm) may determine a cache set to be evicted when a cache miss occurs for a subsequent inference request. As used herein, “evicted” (as used in connection with a cache set) may refer to removing (or erasing or deleting) data from the cache set (or a memory location) to enable other data to be stored in the cache set (or the memory location). For example, information regarding addresses of attribute data of a trained machine learning algorithm may be removed (or erased or deleted) from the cache set to enable information regarding addresses, of other attribute other data of another trained machine learning model, to be stored in the cache set.

In some situations, the replacement algorithm takes may take into account the LRU algorithm (also referred to as the modified LRU algorithm) along with whether new attribute data are to use a single cache set or multiple cache sets. Additionally, the replacement algorithm may take into account whether currently allocated (or used) cache sets are a single cache set or multiple cache sets. With respect to the LRU algorithm, a next cache set to be allocated for a range of addresses (or, alternatively, to be evicted) may be preemptively determined while a current inference is being performed (e.g., is in progress), which may take numerous clock cycles. In some implementations, a count may be set to 0 when a cache set is allocated, and incremented for each inference request that does not cause a cache hit with respect to the cache set. The cache set that has the largest count represents a cache set that has not been used for a time longer than any other cache set.

By using the inference cache as described herein, a cost of repeated loading of attribute data into an inference engine may be mitigated. Additionally, using the inference cache as described herein preserves time that would have been consumed by repeated loading attribute data. Accordingly, using the inference cache as described may increase a speed of performing inferences. Additionally, using the inference cache as described herein enables allocation (of one or more cache sets) for different machine learning models with different sizes of attribute data. In contrast, a prior art cache (or normal processor cache) has a specific number of bytes associated with each cache set and, accordingly, handles data of a same size.

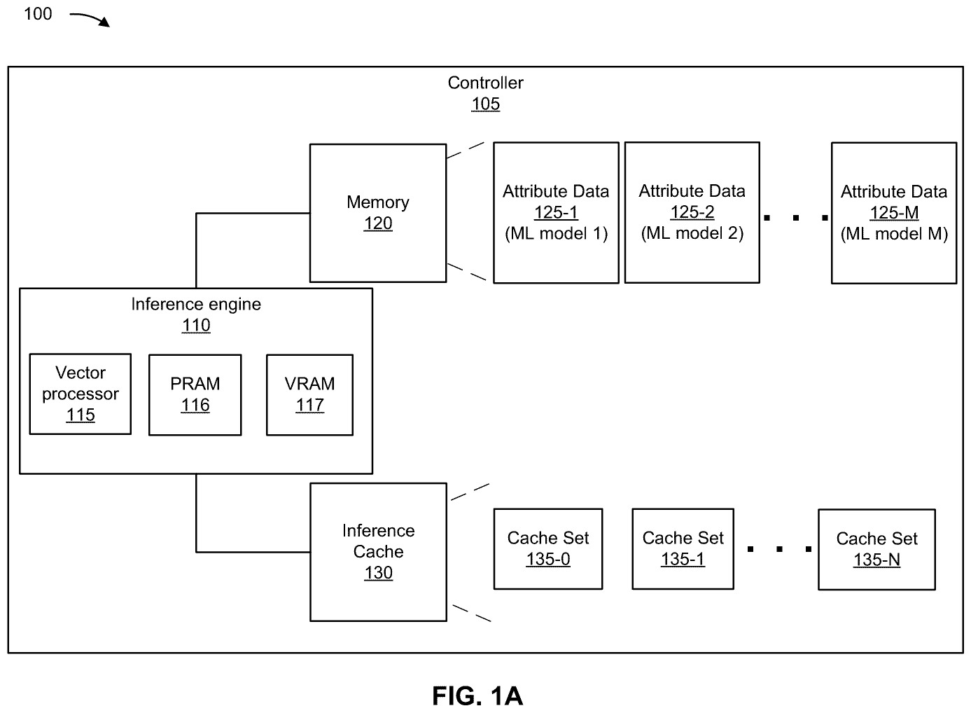

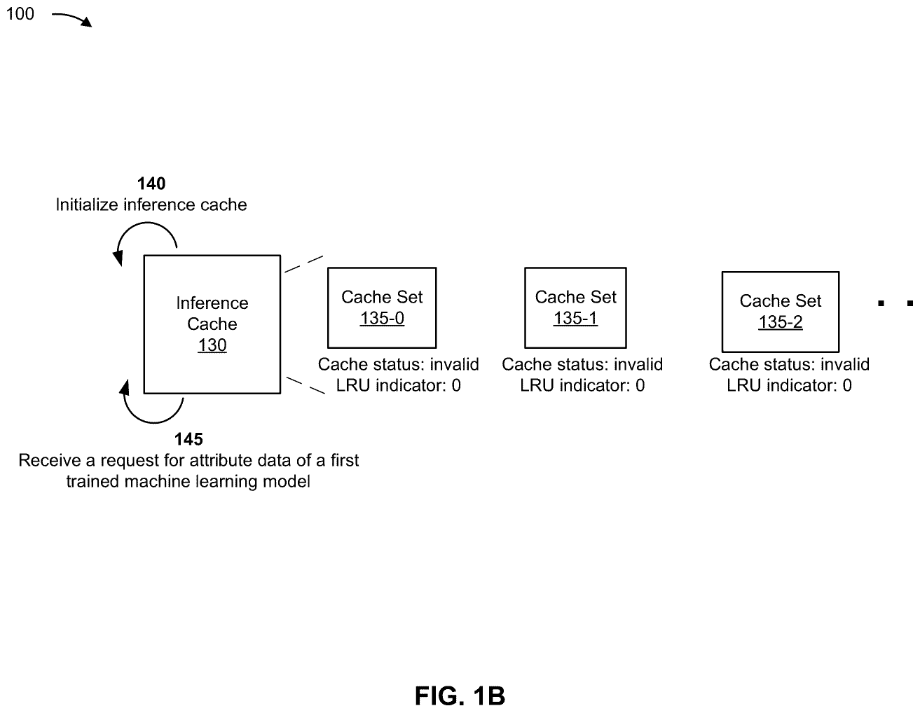

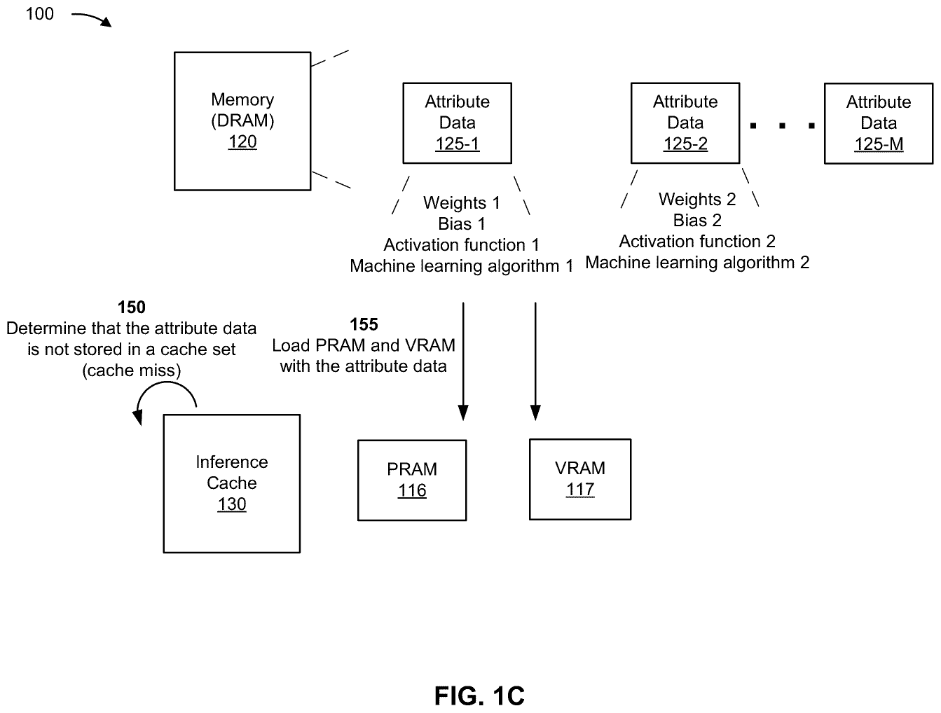

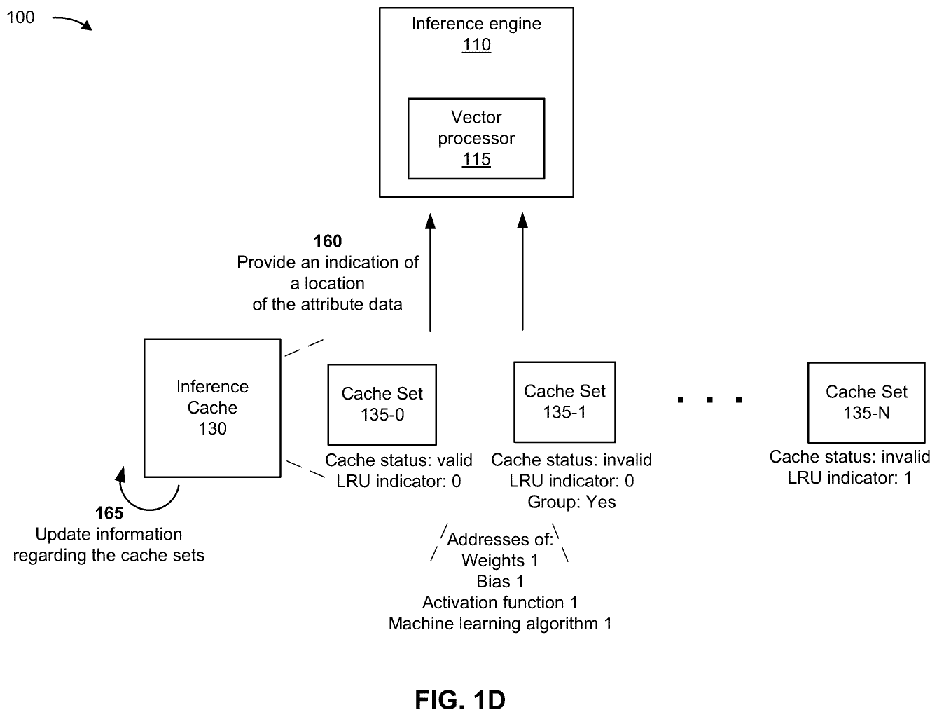

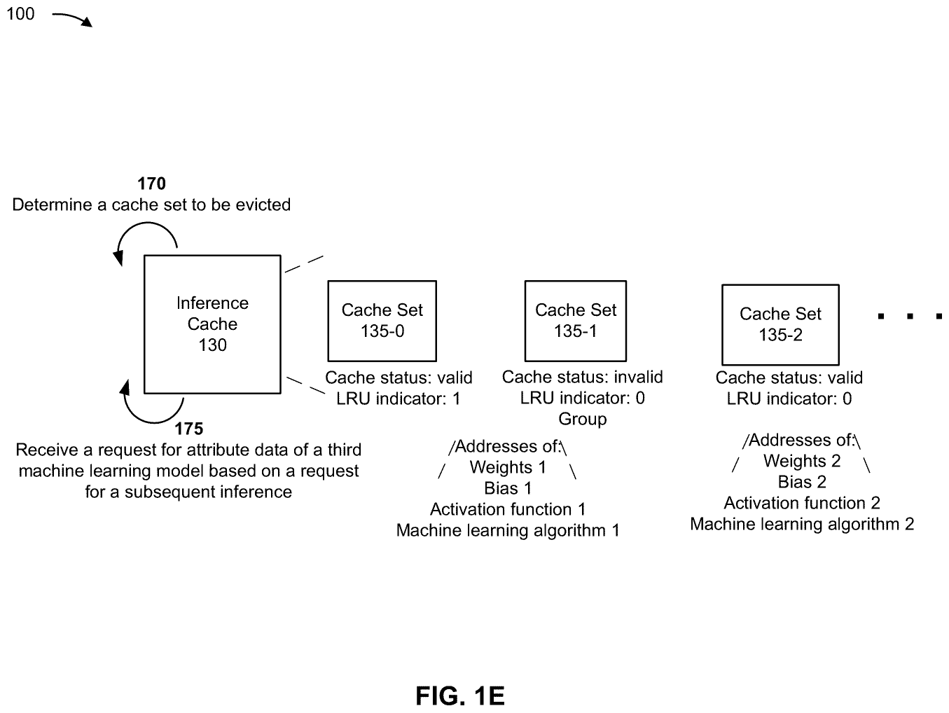

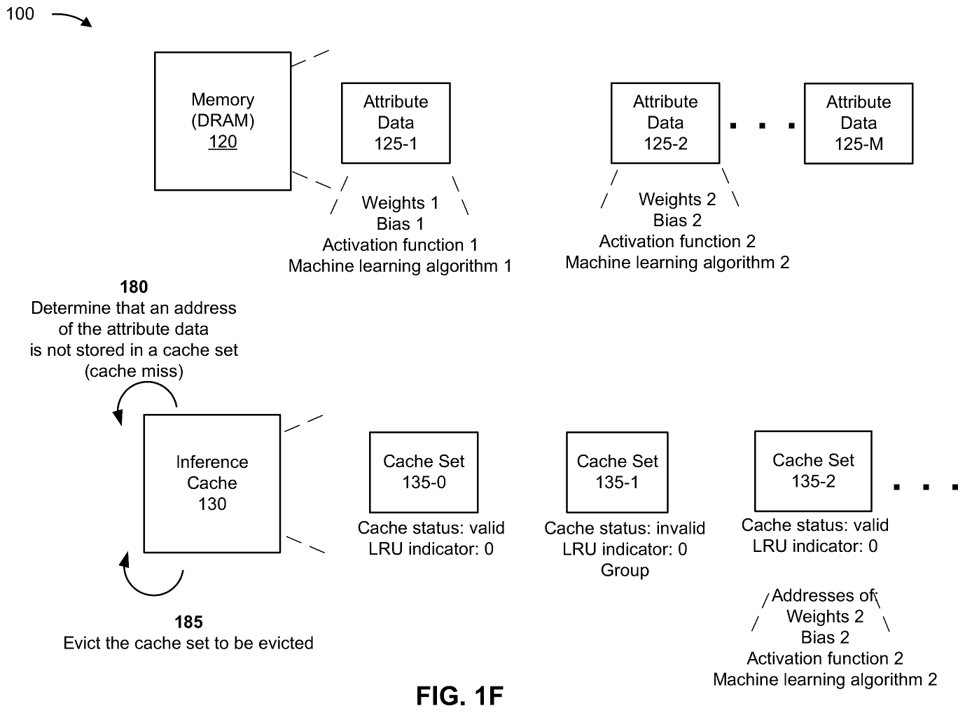

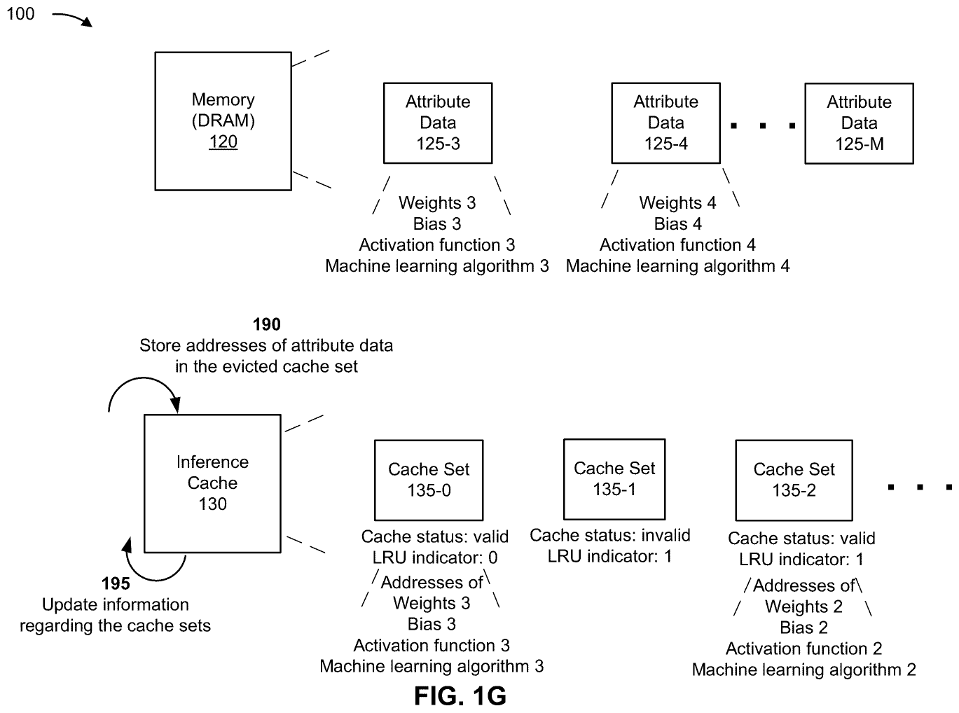

FIGS. 1A-1G are diagrams of an example 100 associated with caching attribute data of attributes of trained machine learning models. As shown in FIGS. 1A-1G, example 100 includes a controller 105. In some examples, controller 105 may include a CPU or a GPU (instead of or in addition to a vector processor). As shown in FIG. 1A, controller 105 may include an inference engine 110, a memory 120, and an inference cache 130. Inference engine 110 may apply logical rules (e.g., associated with attribute data of a trained machine learning model) to an input and generate an output. As shown in FIG. 1A, inference engine 110 may include a vector processor 115.

Vector processor 115 may retrieve, from memory 120, attribute data of attributes of multiple trained machine learning models (e.g., different trained machine learning models). In some implementations, vector processor 115 may retrieve attribute data of a first machine learning model, or retrieve attribute data of a second machine learning model, and so on. In some examples, vector processor 115 may perform different inferences of different trained machine learning models using the respective attribute data. Vector processor 115 may include instructions that may be used to process the attribute data to perform the inferences, as explained herein. For example, inference engine 110 may receive (e.g., from memory 120 or from inference cache 130) attribute data of a first trained machine learning model and perform one or more inferences using the first trained machine learning model, receive (e.g., from memory 120 or from inference cache 130) attribute data of a second trained machine learning model and perform one or more inferences using the second trained machine learning model, and so on. Inference engine 110 may operate as an interface between vector processor 115 and other elements described in connection with FIGS. 1A-1G. Inference engine 110 may instruct vector processor 115 on when to perform an inference, on a location of attribute data, among other examples. As shown in FIG. 1A, vector processor 115 may include a parameter random-access memory (PRAM) 116 and a vector random-access memory (VRAM) 117. From the perspective of inference cache 130, PRAM 116 and VRAM 117 may include a data array of inference cache 130. In accordance with implementations described herein, a cache hit may indicate that attribute data (associated with the cache hit) is stored in PRAM 116 and in VRAM 117. Inference cache 130 may provide, to vector processor 115, a starting location of the attribute data in PRAM 116 or in VRAM 117. PRAM 116 and VRAM 117 may be directly accessible by vector processor 115. Addresses of PRAM 116 may store machine learning model algorithms of trained machine learning models. For example, PRAM 116 may store parameters that define a structure of the trained machine learning models. Addresses of VRAM 117 may store parameters of the trained machine learning models, such as weights and biases of the trained machine learning models. In some implementations, as shown in FIG. 1A, PRAM 116 and VRAM 117 may be included in vector processor 115 to be enable low latency and high bandwidth when accessing attribute data of the trained machine learning models.

Memory 120 may store attribute data of attributes of different trained machine learning models. For example, as shown in FIG. 1A, memory 120 may store attribute data 125-1 of a first trained machine learning model, attribute data 125-2 of a second trained machine learning model, attribute data 125-3 of a third trained machine learning model, up to attribute data 125-M of an mth trained machine learning model (individually “attribute data 125”). In some implementations, memory 120 may include a DRAM. In some implementations, attribute data 125 of a trained machine learning model may identify some, or all, of weights, biases, a structure or architecture, a machine learning algorithm, or an activation function of the trained machine learning model.

In some implementations, memory 120 may copy attribute data, stored in memory 120, to the addresses of PRAM 116 and the addresses of VRAM 117. As shown in FIG. 1A, PRAM 116 and VRAM 117 may be included in inference engine 110.

Inference cache 130 may include multiple cache sets. Inference cache 130 may include an allocatable unit of memory that is allocated to store addresses of data, such as addresses of attribute data (of trained machine learning models) stored in PRAM 116 and VRAM 117. PRAM 116 and VRAM 117 may form a memory associated with inference cache 130. A cache set may point to (or identify) a location (or region) of PRAM 116 and VRAM 117. When a cache hit occurs on a particular cache set, inference cache 130 may provide an address of the location (or region) of attribute data to inference engine 110. As shown in FIG. 1A, as an example, inference cache 130 may include a cache set 135-0, a cache set 135-1, up a cache set 135-N (individually “cache set 135” and collectively “cache sets 135”). Cache sets 135 may be associated with respective ranges of addresses of PRAM 116 and of VRAM 117. For example, cache sets 135 may identify respective ranges of addresses, of PRAM 116 and of VRAM 117, that store attribute data for different trained machine learning models. Cache sets 135, PRAM 116, and VRAM 117 may be components of inference cache 130. For example, PRAM 116 and VRAM 117 may operate as data arrays of inference cache 130 and cache sets 135 may operate as tag arrays of inference cache 130.

For example, cache set 135-0 may point to (or identify) a first range of addresses (e.g., VRAM 0 to 4999 and PRAM 0 to 49), cache set 135-1 may point to (or identify) a second range of addresses (e.g., VRAM 5000 to 9999 and PRAM 50 to 99), and so on. Inference cache 130 may include information identifying the different ranges of addresses associated with cache sets 135. In some implementations, cache sets 135 may include information identifying the different ranges of addresses. The ranges of addresses discussed herein are merely provided as examples.

In some implementations, inference cache 130 and cache sets 135 may track the addresses of the PRAM and the addresses of the VRAM of the trained machine learning models. For example, cache sets 135 may store (e.g., in registers) information that identifies addresses (or address ranges) of PRAM 116 (also referred to as PRAM addresses) and identifies addresses (or address ranges) of VRAM 117 (also referred to as VRAM addresses). In some examples, inference cache 130 may cause memory 120 to provide a copy of attribute data of a trained machine learning model to vector processor 115 (e.g., to be stored in PRAM 116 and VRAM 117).

In some situations, a cache set 135 may indicate if data, stored in a range of addresses of PRAM 116 or VRAM 117, is valid. If the data is valid, the cache set 135 may indicate a location in memory 120 from which the data was copied (e.g., to PRAM 116 or VRAM 117). In some examples, a request for an inference (also referred to as inference request) may be generated by controller 105. The request may identify a trained machine learning and information identifying a location, in memory 120, that stores attribute data of the trained machine learning model. For example, the request may identify a pointer to the location (e.g., a range of addresses of memory 120). Inference cache 130 may search cache sets 135 to determine if a cache set 135 includes information identifying the range of address (identified in the request). If a cache set 135 includes information matching the range of address, then inference cache 130 may determine that the attribute data for the trained machine learning model is already present in VRAM 117 and PRAM 116 at the address range identified by the cache set 135. In other words, the cache set 135 may indicate that the attribute data has already been loaded in VRAM 117 and PRAM 116 and, accordingly, the cache set 135 may indicate a cache hit. Conversely, a cache miss may occur if the cache sets 135 do not include information identifying the range of addresses. If a cache miss occurs, inference cache 130 may determine a cache set 135 to store information identifying the range of addresses. In this regard, inference cache 130 may overwrite data stored in the VRAM and PRAM addresses identified by the cache set 135. For example, inference cache 130 may cause memory 120 to copy the attribute data, of the trained machine learning model, from memory 120 into the VRAM and PRAM the addresses identified by the cache set 135 and may cause inference engine 110 to perform the inference using the attribute data at the VRAM and PRAM addresses. While VRAM 117 and PRAM 116 may store attribute data of multiple trained machine learning models, a trained machine learning model may behave as if VRAM 117 and PRAM 116 only store the attribute data for the trained machine learning model starting at a same address (e.g., address 0, 100, among other examples). A cache set may identify a starting address for a range of VRAM addresses and these addresses may increment by a size of the attribute data for a trained machine learning model. For example, if the size of the attribute data is 5000, then a first cache set may store a starting address of 0, a second cache set may store a starting address of 5000, a third cache set may store a starting address of 10000, and so on. An offset, provided by a particular cache set when a cache hit occurs for the particular cache set, may be a starting VRAM address assigned to the particular cache set. This starting address may be a location in VRAM 117 where the attribute data has been previously loaded (or stored). Vector processor 115 may use this offset to add to all the VRAM addresses that refer to attribute data. As an example, if an inference request identifies weights that are expected to be in VRAM address 100 and if the offset is 1000, then the actual VRAM address may be 1100 (e.g., 100+1000).

In some examples, inference cache 130 may indicate one or more of information regarding a cache set 135, such as information indicating whether the cache set 135 is being used to store information regarding a range of respective PRAM addresses and VRAM addresses for attribute data 135 (e.g., a “valid status”), information indicating whether the respective range of PRAM addresses and VRAM addresses stored by the cache set 135 is available to be used to store attribute data 125 (e.g., a “invalid status”), information indicating that the cache set 135 is not to be used to store an address (or a range of addresses) for attribute data 125 (e.g., an “unusable status”), indicating recency of access (e.g., an LRU indicator), information indicating whether the cache set 135 is part of a group of cache sets that store addresses of attribute data 125 with a size that exceeds a size of a range of addresses identified by a single cache set 135, and an address of memory 120 that was used to load data into PRAM 116 and VRAM 117 if the cache set 135 is marked “valid.”

As shown in FIG. 1B, and by reference number 140, controller 105 may initialize inference cache 130. For example, a core (not shown) of controller 105 may initialize inference cache 130. The core may be associated with inference cache 130. In some situations, inference cache 130 may be initialized when a host device (not shown and including or associated with controller 105) is powered on or is rebooted. In this regard, data stored by inference cache 130 (prior to the device being powered on or being rebooted) may be deleted.

When initializing inference cache 130, controller 105 may set a cache status, of cache sets 135, to “invalid” to indicate that addresses, identified by cache sets 135, are available to store data, such as attribute data 125. Additionally, controller 105 may reset a recency of access of cache sets 135. For example, controller 105 may set an LRU indicator, of cache sets 135, to “0.” In this regard, an increase in a value of the LRU indicator may indicate a decrease in recency of access. For example, if an LRU indicator of cache set 135-1 is 1 and an LRU indicator of cache set 135-2 is 2, then cache set 135-1 may be the most recently accessed cache set out of cache set 135-1 and cache set 135-2.

In some situations, inference cache 130 may set a cache status of a particular cache set 135 to “unusable” to indicate that the particular cache set 135 may not be used to store a starting address of attribute data. For example, if VRAM 117 includes 100,000 addresses and if a particular cache set 135 identifies addresses 100,000 to 104,999, then inference cache 130 may set the cache status of the particular cache set 135 to “unusable” because the particular cache set 135 is allocated for a range of address that exceeds a range of address of VRAM 117.

In some situations, upon inference cache 130 being initialized, PRAM 116 and VRAM 117 may be loaded with attribute data of one or more trained machine learning models. Cache sets 135 may store information regarding range of addresses of PRAM 116 and the VRAM 117 for attribute data 125 of a respective trained machine learning model.

In some implementations, the cache set 135 to be evicted may be the first cache set of inference cache 130, which first cache set is cache set 135-0). In some implementations, the cache set 135 to be evicted may be identified after another cache set 135 is evicted. The replacement algorithm may take into account the modified LRU algorithm along with whether the attribute data to be loaded requires a single or multiple cache sets. Additionally, the replacement algorithm may take into account whether currently allocated (or used) cache sets are a single cache set or multiple cache sets.

As shown in FIG. 1B, and by reference number 145, inference cache 130 may receive a request for attribute data of a first trained machine learning model. For example, inference cache 130 may receive the request (hereinafter “pending request”) based on a prior request for an inference to be performed using the first trained machine learning model. In some situations, inference cache 130 may receive the pending request from inference engine 110. In some situations, inference cache 130 may receive the pending request from the core associated with inference cache 130.

In some implementations, the request (for the inference) may be received by the core of controller 105 from a host device (not shown). The request may include information identifying the trained machine learning model that is to be used to perform the inference or that may be used to identify the trained machine learning model that is to be used to perform the inference. In this regard, the core or inference engine 110 may identify the trained machine learning model from the request and provide, to inference cache 130, the request for the attribute data of the first trained machine learning model. In some implementations, the request may identify attribute data 125 (for the respective trained machine learning model) using one or more addresses (or a range of addresses) of the attribute data in memory 120. The one or more addresses (or range of addresses) may be used to determine whether a cache hit has occurred or whether a cache miss hit has occurred. As explained herein, a cache hit may occur if the one or more addresses (or range of addresses) are stored by a cache set 135. Conversely, a cache miss may occur if cache sets 135 do not store the one or more addresses (or range of addresses). As explained herein, if a cache miss occurs, inference cache 130 may cause memory 120 to copy the attribute data 125 of the respective trained machine learning model to PRAM 116 and VRAM 117. Inference cache 130 may update the cache status of a cache set 135 associated with the one or more addresses to indicate “valid.” Additionally, inference cache 130 may store, in the cache set 135, the range of addresses used in PRAM 116 and VRAM 117 for the attribute data. As shown in FIG. 1C, memory 120 may store attribute data of different trained machine learning models. For example, the attribute data 125-1 of the first trained machine learning model may include weights 1, bias 1, activation function 1, and machine learning algorithm 1. The attribute data 125-2 of the second trained machine learning model may include weights 2, bias 2, activation function 2, and machine learning algorithm 2.

As shown in FIG. 1C, and by reference number 150, inference cache 130 may determine that the attribute data 125 for the request is not stored in a cache set, i.e. a cache miss. As explained herein, the request may identify a starting address of memory 120 (for the attribute data) and a length of the attribute data starting at the starting address.

In some implementations, inference cache 130 may search information regarding the addresses pointed to (or identified by) cache sets 135 to determine whether the starting address (identified by the request) match the addresses pointed to (or identified by) cache sets 135. Because inference cache 130 has been initialized, addresses may not be stored on cache sets 135. Accordingly, inference cache 130 may determine that a match does not exist for the address identified by the request. Therefore, a cache miss has occurred. Inference cache 130 may determine that the cache miss has occurred.

As shown in FIG. 1C, and by reference number 155, inference cache 130 may load PRAM 116 and VRAM 117 with the attribute data copied from memory 120. For example, based on the cache miss occurring, inference cache 130 may cause the attribute data 125-1 of the first trained machine learning model to be provided to PRAM 116 and VRAM 117 from memory 120. In some implementations, inference cache 130 may cause vector processor 115 to fetch a copy of the attribute data 125-1 and store the attribute data in addresses of PRAM 116 and VRAM 117. In some implementations, inference cache 130 may use information included in the request (e.g., the starting address and the length) to cause memory 120 to provide a copy of the attribute data to PRAM 116 and VRAM 117.

In some implementations, based on the cache miss occurring, a cache set 135 may be chosen (e.g., based on the LRU algorithm described herein). The cache set 135 may point to (or identify) starting addresses in PRAM 116 and VRAM 117. Attribute data 125-1 may be copied from memory 120 to the starting addresses in PRAM 116 and VRAM 117. In some situations, based on a size of the attribute data 125, inference cache 130 may store information regarding addresses of the attribute data in a group of cache sets 135. The group of cache sets 135 may be contiguous cache sets. In some implementations, when storing the information regarding the addresses of the attribute data in a group of cache sets 135, inference cache 130 may store the information regarding the addresses of the attribute data starting at a first cache set of inference cache 130 (e.g., starting with cache set 135-0). As an example, inference cache 130 may store the information regarding the addresses of the attribute data (of the first machine learning model) in cache set 135-0 and in cache set 135-1. In some implementations, inference cache 130 may store the information regarding the addresses of the attribute data 125 in contiguous cache sets starting at a cache set 135 different than cache set 135-0. The information regarding the addresses may be stored in contiguous cache sets 135 because inference engine 110 may perceive the first trained machine learning model, being executed, as being stored in contiguous memory locations in PRAM 116 and VRAM 117. Storing the information regarding the address in contiguous cachet sets 135 maintains that perception for inference engine 110. Inference cache 130 stores attribute data for multiple trained machine learning models. When a cache hit occurs, inference cache 130 may provide, to inference engine 110, information regarding the starting address stored by a cache set 135. The starting address may identify a starting location of the attribute data in PRAM 116 and VRAM 117. That way, inference engine 110 goes through the same process no matter the inference to be performed and the trained machine learning model to be used for the inference. Inference engine 110 may simply know where contiguous PRAM data starts and where contiguous VRAM data starts.

Vector processor 115 may treat the starting address (provided by inference cache 130) as an offset to be added to PRAM and VRAM addresses whenever vector processor 115 retrieves attribute data for an inference being performed.

As shown in FIG. 1D, and by reference number 160, inference cache 130 may provide an indication of a location of the attribute data 125 for the inference. In some implementations, based on the indication that a cache miss has occurred, inference cache 130 may provide a request to memory 120 to obtain the attribute data 125 and may obtain the attribute data 125 from memory 120. In some examples, inference cache 130 may determine that a cache hit has occurred and provide an indication of a location of the attribute data in PRAM 116 and VRAM 117.

As show in FIG. 1D, and by reference number 165, inference cache 130 may update information regarding the cache sets. For example, based on loading PRAM 116 and VRAM 117 with the attribute data 125 of the first machine learning model, inference cache 130 may update information regarding cache sets 135. For example, because cache set 135-0 stores the information regarding the addresses of the attribute data 125, inference cache 130 may update information regarding cache set 135-0 to indicate that cache set 135-0 is storing data. For example, inference cache 130 may set a cache status of cache set 135-0 to “valid” to indicate that cache set 135-0 is storing data. Additionally, inference cache 130 may update an LRU indicator of cache set 135-0 to 0 (e.g., reset the LRU indicator). Additionally, inference cache 130 may increment the LRU indicator of other cache sets 135-1.

As explained in the example above, the information regarding the addresses of the attribute data 125 (for the first trained machine learning model) may be stored in a group of multiple cache sets including cache set 135-0 and cache set 135-1. In this regard, because cache set 135-0 is a first cache set of the group, information regarding cache set 135-0 (e.g., cache status and LRU indicated) may be updated. Information regarding other cache sets of the group (e.g., cache set 135-1) may be updated to indicate that cache set 135-1 is part of a group of cache sets. As shown in FIG. 1D, for example, the cache status of cache set 135-0 may be updated to “valid” to indicate that cache set 135-0 is storing data. Notwithstanding the foregoing, inference cache 130 may update the information regarding the other cache sets 135 of the group to indicate that the other cache sets are part of the group. For example, as shown in FIG. 1D, the information regarding cache set 135-1 may be updated to indicate that cache set 135-1 is part of a group of cache sets 135 by indicating “Group: Yes.” The cache status of cache set 135-1 may not need to be updated to “valid” because of the group status being updated to “Yes,” indicating that cache set 135-1 is storing part of the data for the group. For example, cache set 135-1 may store addresses of some of weights 1, bias 1, activation function 1, or machine learning algorithm 1, or any combination.

As shown in FIG. 1E, and by reference number 170, inference cache 130 may determine a cache set to be evicted. For example, inference cache 130 may determine the cache set to be evicted after the request for the attribute data of the first trained machine learning model and before a subsequent request for attribute data. In other words, inference cache 130 may determine the cache set to be evicted between two requests for attribute data. For example, inference cache 130 may determine the cache set to be evicted if necessary by the subsequent request. A subsequent inference, associated with the subsequent request, may not be performed until the inference (associated with the request preceding the subsequent request) is completed. Inference cache 130 may determine the cache set to be evicted, as described herein, because performing the inference may consume a substantial amount of time (e.g., hundreds of clock cycles, thousands of clock cycles, or tens of thousands of clock cycles). Determining the cache set to be evicted in this manner may enable the use of LRU schemes of varying levels of complexity because of the substantial amount of time consumed when performing the inference.

Inference cache 130 may determine the cache set to be evicted based on a replacement algorithm. In some situations, the replacement algorithm may be based on a recency of access of cache sets 135. For example, the replacement algorithm may be based on the LRU indicator of cache sets 135. As show in FIG. 1E, for example, inference cache 130 may determine that the LRU indicator of cache set 135-0 exceeds the LRU indicator of other cache sets 135. Accordingly, inference cache 130 may identify cache set 135-0 as the cache set to be evicted if the subsequent request for an inference results in a cache miss. In some examples, inference cache 130 may select a cache set with non-valid information because such cache set may be indicative of no attribute data being stored on PRAM 116 and VRAM 117 at addresses identified by the cache set. Alternatively, if inference cache 130 does not identify a cache set with non-valid information, inference cache 130 may select a cache set based on the LRU algorithm (e.g., a cache set with the highest count with respect to LRU).

In some situations, the cache set to be evicted may be part of a group of cache sets. For example, the cache set may be a first cache set of the group of cache sets. In this regard, if the first cache set is evicted, other cache sets of the group of cache sets may also be evicted.

As shown in in FIG. 1E, and by reference number 175, inference cache 130 may receive a request for attribute data of a third machine learning model. Inference cache 130 may receive the request (hereinafter “subsequent request”) in a manner similar to the manner described in connection with FIG. 1B. In some situations, inference cache 130 may receive the subsequent request as a result of a request for an inference to be performed using the third trained machine learning model.

As shown in in FIG. 1F, and by reference number 180, inference cache 130 may determine that an address of the attribute data 125 associated with the subsequent request, is not stored in a cache set 135. In some implementations, the request may identify a starting address, of memory 120, that stores the attribute data of the third trained machine learning model and may also identify a length of the attribute data starting at the starting address. As explained above in connection with FIG. 1C, inference cache 130 may search the information regarding the addresses stored by cache sets 135 to determine whether the starting address identified in the subsequent request is identified by a cache set 135. In other words, inference cache 130 may check all cache sets 135 to see if the information of cache sets 135 includes the starting address identified by the subsequent request.

Based on the search, inference cache 130 may determine that cache sets 135 do not store the starting address of the attribute data of the third trained machine learning algorithm. Accordingly, a cache miss may occur and inference cache 130 may determine that a cache miss has occurred, in a manner similar to the manner described above in connection with FIG. 1C. As shown in FIG. 1E, cache set 135-0 and cache set 135-1 may store starting addresses for the attribute data of the first trained machine learning model and cache set 135-2 may store starting addresses for attribute data of the second trained machine learning model. For example, cache set 135-0 and cache set 135-1 may store addresses (in memory 120) of weights 1, bias 1, activation function 1, and machine learning algorithm 1, as well as respective addresses in PRAM 116 and VRAM 117, while cache set 135-2 may store addresses (in memory 120) of weights 2, bias 2, activation function 2, and machine learning algorithm 2, as well as respective addresses in PRAM 116 and VRAM 117. Remaining cache sets 135 may not store data or may store starting addresses of attribute data of one or more other trained machine learning models.

As shown in FIG. 1F, and by reference number 185, inference cache 130 may evict the cache set to be evicted. For example, based on determining that the cache miss has occurred, inference cache 130 may determine that a cache set 135 is to be overwritten with the starting address of the attribute data of the third machine learning model. In this regard, inference cache 130 may determine whether a cache set 135 is available to store the starting address of the attribute data. Accordingly, inference cache 130 may identify a cache set 135 with a cache status indicating invalid (and that is not part of a group of cache sets storing data). In some implementations, inference cache 130 may load the attribute data from memory 120 into predetermined locations of PRAM 116 and VRAM 117 associated with the cache set 135 and load an identifier of (or a pointer to) the starting address of memory 120 for that attribute data into the cache set 135.

If inference cache 130 does not identify a cache set 135 with a cache status indicating invalid, inference cache 130 may determine to evict the cache set to be evicted. In other words, inference cache 130 may determine to evict the cache set because all cache sets 135 are storing data or not usable. Similarly, if inference cache 130 does not identify a cache set 135 with a cache status indicating invalid and indicating that the cache set 135 is part of a group, inference cache 130 may determine to evict the cache set to be evicted. In this regard, the cache set 135 being part of a group may provide an indication that the cache set 135 is storing a portion of attribute data of a trained machine learning model.

In the example described herein, cache set 135-0 has been identified as the cache set to be evicted. The cache status of cache set 135-0 is “valid,” the cache status of cache set 135-1 is “invalid” but cache set 135-1 is part of a group of cache sets, and the cache status of cache set 135-2 not part of the group (and of other cache sets not part of the group) are not updated. Accordingly, inference cache 130 may evict cache set 135-0. Additionally, inference cache 130 may update the cache status of cache set 135-0 to invalid to indicate that cache set 135-0 is not storing data. Based on the foregoing, if a group is evicted, every cache set in the group is marked invalid except for the first cache set. The first cache set will remain valid because the first cache set will be re-used but the group status will be set to No (or 0) if only a single cache set is being assigned to the request. Additionally, inference cache 130 may update a group status of cache sets 135, of the group, to indicate that such cache sets 135 are no longer part of a group.

As shown in FIG. 1G, and by reference number 190, inference cache 130 may store addresses of the attribute data of the third trained machine learning model in the evicted cache set 135-0. For example, after evicting cache set 135-0, inference cache 130 may store, in cache set 135-0, addresses (in memory 120) of the attribute data of the third trained machine learning model (e.g., addresses weights 3, bias 3, activation function 3, and machine learning algorithm 3), in a manner similar to the manner described above in connection with FIG. 1C. Additionally, inference cache 130 may cause a copy of the attribute data of the third trained machine learning model (from memory 120) to be stored at addresses of PRAM 116 and VRAM 117 corresponding to the addresses (of the attribute data) stored in cache set 135-0. In some implementations, prior to the copy of the attribute data being stored in PRAM 116 and VRAM 117, inference cache 130 may cause any data stored at the addresses PRAM 116 and VRAM 117 to be evicted. In other words, inference cache 130 may cause any data stored at the addresses PRAM 116 and VRAM 117 to be erased. As shown in FIG. 1G, for example, based on a size of the attribute data, inference cache 130 may store the addresses of the attribute data in a single cache set (e.g., cache set 135-0).

As shown in FIG. 1G, and by reference number 195, inference cache 130 may update information regarding the cache sets. For example, after loading cache set 135-0, inference cache 130 may update cache sets 135, in a manner similar to the manner described above in connection with FIG. 1D. As shown in FIG. 1G, for example, based on storing the addresses in cache set 135-0, inference cache 130 may update the cache status of cache set 135-0 to valid and may reset the LRU indicator to 0. Additionally, inference cache 130 may increment the LRU indicator of other cache sets 135 (e.g., cache set 135-1, 135-2, and so on).

Implementations described herein are directed to increasing a rate of inference performed by providing a caching mechanism to track different attribute data stored in the inference engine.

A duration of a performance of an inference may be reduced. As explained herein, the inference cache may track attribute data provided to the vector processor.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

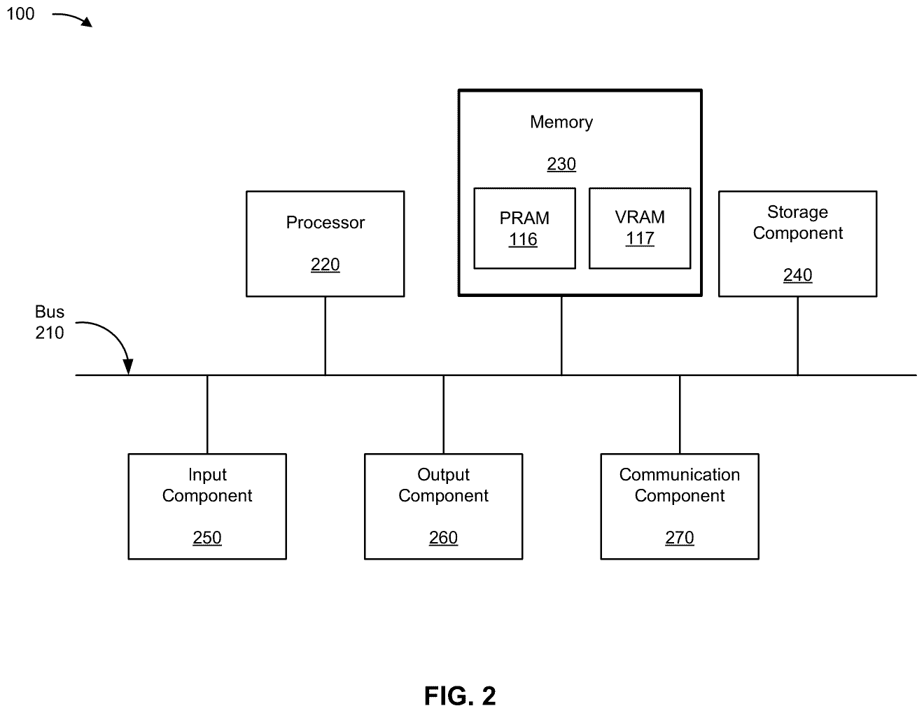

FIG. 2 is a diagram of example components of a device 200, which may correspond to controller 105. In some implementations, controller 105 may include one or more devices 200 and/or one or more components of device 200. As shown in FIG. 2, device 200 may include a bus 210, a processor 220, a memory 230, a storage component 240, an input component 250, an output component 260, and a communication component 270.

Bus 210 includes a component that enables wired and/or wireless communication among the components of device 200. Processor 220 includes a central processing unit, a graphics processing unit, a microprocessor, a controller, a microcontroller, a digital signal processor, a field-programmable gate array, an application-specific integrated circuit, and/or another type of processing component. Processor 220 is implemented in hardware, firmware, or a combination of hardware and software. In some implementations, processor 220 includes one or more processors capable of being programmed to perform a function. Memory 230 includes a random access memory, a read only memory, and/or another type of memory (e.g., a flash memory, a magnetic memory, and/or an optical memory). Memory 230 may include memory 120, include PRAM 116, include VRAM 117, include cache sets 135, or a combination of the foregoing.

Storage component 240 stores information and/or software related to the operation of device 200. For example, storage component 240 may include a hard disk drive, a magnetic disk drive, an optical disk drive, a solid state disk drive, a compact disc, a digital versatile disc, and/or another type of non-transitory computer-readable medium. Input component 250 enables device 200 to receive input, such as user input and/or sensed inputs. For example, input component 250 may include a touch screen, a keyboard, a keypad, a mouse, a button, a microphone, a switch, a sensor, a global positioning system component, an accelerometer, a gyroscope, and/or an actuator. Output component 260 enables device 200 to provide output, such as via a display, a speaker, and/or one or more light-emitting diodes. Communication component 270 enables device 200 to communicate with other devices, such as via a wired connection and/or a wireless connection. For example, communication component 270 may include a receiver, a transmitter, a transceiver, a modem, a network interface card, and/or an antenna.

Device 200 may perform one or more processes described herein. For example, a non-transitory computer-readable medium (e.g., memory 230 and/or storage component 240) may store a set of instructions (e.g., one or more instructions, code, software code, and/or program code) for execution by processor 220. Processor 220 may execute the set of instructions to perform one or more processes described herein. In some implementations, execution of the set of instructions, by one or more processors 220, causes the one or more processors 220 and/or the device 200 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 2 are provided as an example. Device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

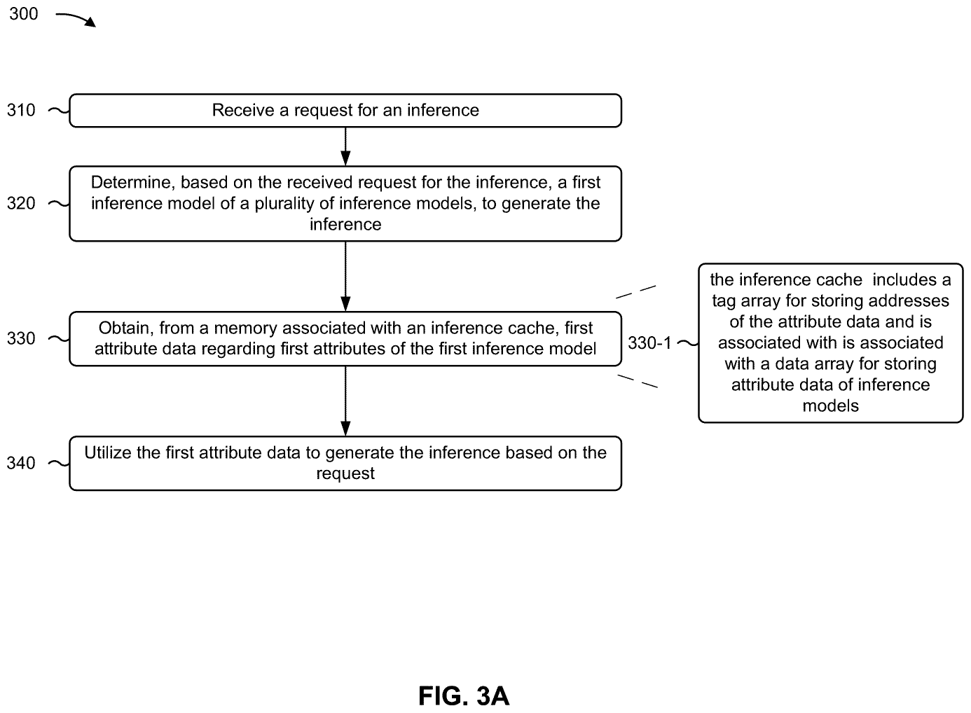

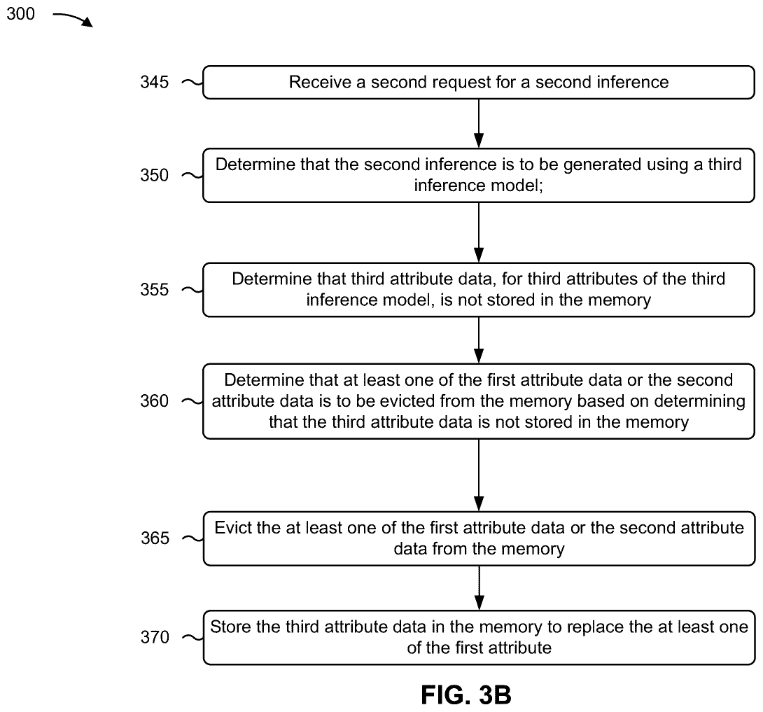

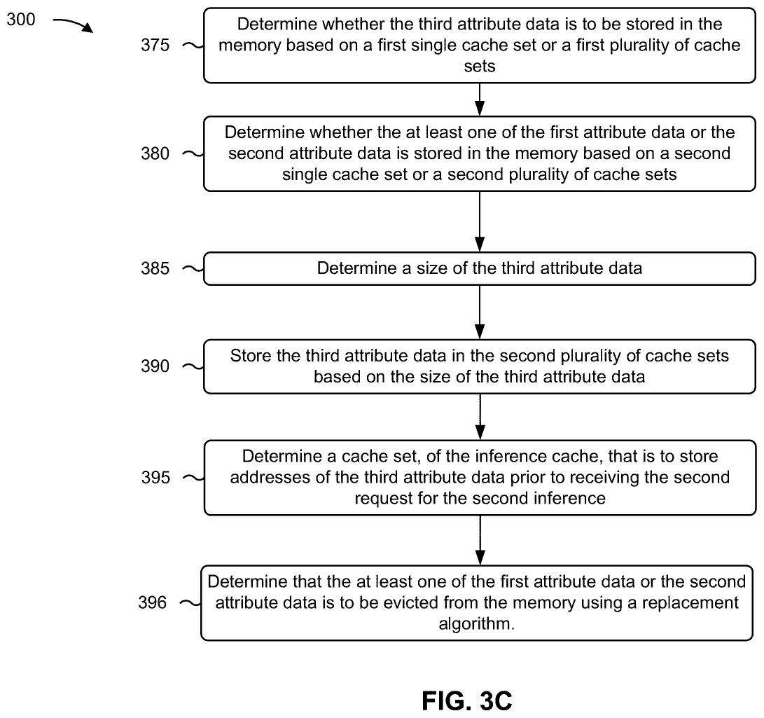

FIGS. 3A-3C are flowcharts of an example process 300 associated with caching attributes of attributes of machine learning models. In some implementations, one or more process blocks of FIGS. 3A-3C may be performed by a controller (e.g., controller 105). In some implementations, one or more process blocks of FIGS. 3A-3C may be performed by another device or a group of devices separate from or including the controller, such as a cache (e.g., inference cache 130). Additionally, or alternatively, one or more process blocks of FIGS. 3A-3C may be performed by one or more components of device 200, such as processor 220, memory 230, storage component 240, input component 250, output component 260, and/or communication component 270.

As shown in FIG. 3A, process 300 may include receiving a request for an inference (block 310). For example, the controller may receive a request for an inference, as described above.

As further shown in FIG. 3A, process 300 may include determining, based on the received request for the inference, a first inference model of a plurality of inference models, to generate the inference (block 320). For example, the controller may determine, based on the received request for the inference, a first inference model of a plurality of inference models, to generate the inference, as described above.

As further shown in FIG. 3A, process 300 may include obtaining, from a memory associated with an inference cache, first attribute data regarding first attributes of the first inference model (block 330). For example, the controller may obtain, from a memory associated with an inference cache, first attribute data regarding first attributes of the first inference model, as described above. A location of the first attribute data, in the memory, may be determined using the inference cache. In some implementations, the inference cache includes a tag array for storing addresses of the attribute data and is associated with a data array for storing attribute (block 330-1).

As further shown in FIG. 3A, process 300 may include utilizing the first attribute data to generate the inference based on the request (block 340). For example, the controller may utilize the first attribute data to generate the inference based on the request, as described above.

In some implementations, the request is a first request and the inference is a first inference. As further shown in FIG. 3B, process 300 may include receiving a second request for a second inference (block 345), determining that the second inference is to be generated using a third inference model (block 350), determining that third attribute data, for third attributes of the third inference model, is not stored in the memory (block 355), determining that at least one of the first attribute data or a second attribute data is to be evicted from the memory based on determining that the third attribute data is not stored in the inference cache (block 360), evicting the at least one of the first attribute data or the second attribute data from the memory (block 365), and storing the third attribute data in the memory to replace the at least one of the first attribute data or the second attribute data (block 370).

In some implementations, determining that the at least one of the first attribute data or the second attribute data is to be evicted from the memory comprises determining whether the third attribute data is to be stored in the memory based on a first single cache set or a first plurality of cache sets (block 375), and determining whether the at least one of the first attribute data or the second attribute data is stored in the memory based on a second single cache set or a second plurality of cache sets (block 380). In some implementations, the first plurality of cache sets, the second plurality of cache sets, or both, are contiguous cache sets.

In some implementations, determining that a size of the third attribute data (block 385), and storing addresses of the third attribute data in the second plurality of cache sets based on the size of the third attribute data (block 390).

In some implementations, process 300 includes determining a cache set, of the inference cache, that is to store addresses of the third attribute data prior to receiving the second request for the second inference (block 395). In some implementations, as shown in FIG. 3C, process 300 may include determining that the at least one of the first attribute data or the second attribute data is to be evicted from the memory comprises determining that the at least one of the first attribute data or the second attribute data is to be evicted from the inference cache using a replacement algorithm (block 396). The replacement algorithm is based on a least-recently-used algorithm.

Although FIGS. 3A-3C shows example blocks of process 300, in some implementations, process 300 may include additional blocks, fewer blocks, different blocks, or differently arranged blocks than those depicted in FIGS. 3A-3C. Additionally, or alternatively, two or more of the blocks of process 300 may be performed in parallel.

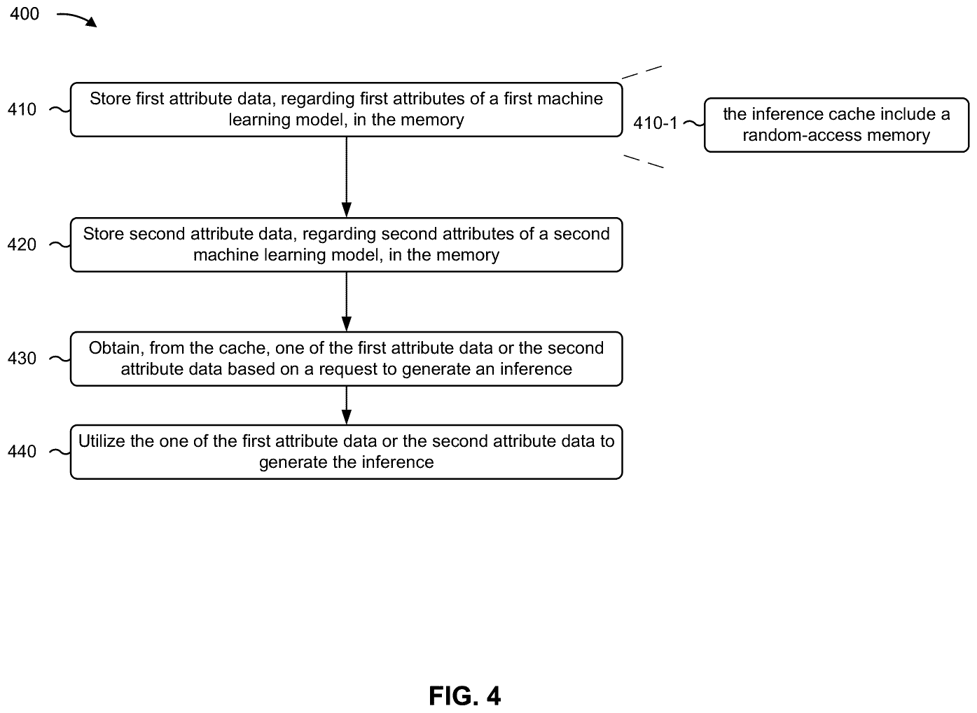

FIG. 4 is a flowchart of an example process 400 associated with caching attributes of attributes of machine learning models. In some implementations, one or more process blocks of FIG. 4 may be performed by a controller (e.g., controller 105). In some implementations, one or more process blocks of FIG. 4 may be performed by another device or a group of devices separate from or including the controller, such as a cache (e.g., inference cache 130). Additionally, or alternatively, one or more process blocks of FIG. 4 may be performed by one or more components of device 200, such as processor 220, memory 230, storage component 240, input component 250, output component 260, and/or communication component 270.

As shown in FIG. 4, process 400 may include storing first attribute data, regarding first attributes of a first machine learning model, in the memory (block 410). For example, the controller may store first attribute data, regarding first attributes of a first machine learning model, in a memory associated with an inference cache, as described above. In some implementations, the first machine learning model is a first trained machine learning model. In some implementations, one or more first cache sets, of the inference cache, include contiguous cache sets. In some implementations, the inference cache is included in a random-access memory.

As further shown in FIG. 4, process 400 may include storing second attribute data, regarding second attributes of a second machine learning model, in the memory (block 420). For example, the controller may store second attribute data, regarding second attributes of a second machine learning model, in the memory, as described above. In some implementations, the second machine learning model is a second trained machine learning model. In some implementations, one or more second cache sets, of the inference cache, include contiguous cache sets.

As further shown in FIG. 4, process 400 may include obtaining, from the memory, one of the first attribute data or the second attribute data based on a request to generate an inference (block 430). For example, the controller may obtain, from the memory, one of the first attribute data or the second attribute data based on a request to generate an inference, as described above. A location of the one of the first attribute data or the second attribute data, in the memory, may be determined using the inference cache.

As further shown in FIG. 4, process 400 may include utilizing the one of the first attribute data or the second attribute data to generate the inference (block 440). For example, the controller may utilize the one of the first attribute data or the second attribute data to generate the inference, as described above. In some examples, the inference cache may include a random-access memory (block 410-1).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

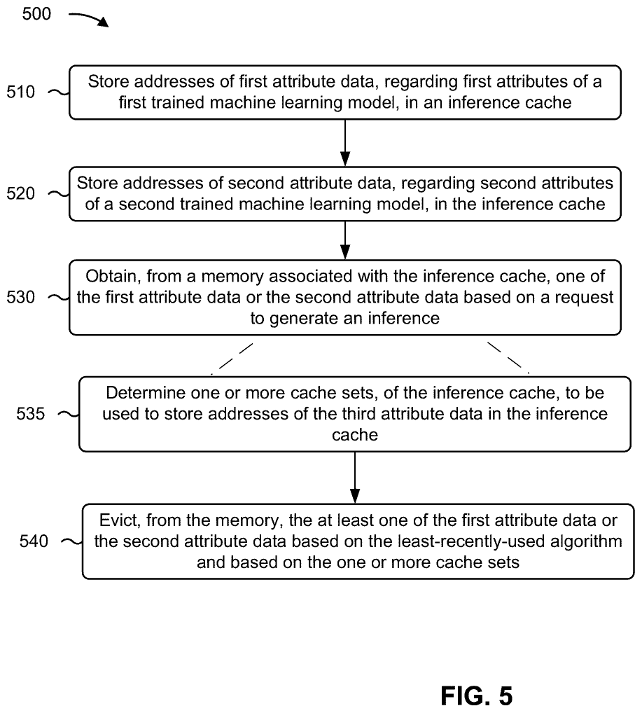

FIG. 5 is a flowchart of an example process 500 associated with caching attributes of attributes of machine learning models. In some implementations, one or more process blocks of FIG. 5 may be performed by a controller (e.g., controller 105). In some implementations, one or more process blocks of FIG. 5 may be performed by another device or a group of devices separate from or including the controller, such as a cache (e.g., inference cache 130). Additionally, or alternatively, one or more process blocks of FIG. 5 may be performed by one or more components of device 200, such as processor 220, memory 230, storage component 240, input component 250, output component 260, and/or communication component 270.

As shown in FIG. 5, process 500 may include storing addresses of first attribute data, regarding first attributes of a first trained machine learning model, in one or more first cache sets of a cache (block 510). For example, the controller may store addresses of first attribute data, regarding first attributes of a first trained machine learning model, in one or more first cache sets of a cache, as described above.

As further shown in FIG. 5, process 500 may include storing addresses of second attribute data, regarding second attributes of a second trained machine learning model, in one or more second cache sets of the cache (block 520). For example, the controller may store addresses of second attribute data, regarding second attributes of a second trained machine learning model, in one or more second cache sets of the cache, as described above.

As further shown in FIG. 5, process 500 may include obtaining, from a memory associated with the inference cache, one of the first attribute data or the second attribute data based on a request to generate an inference (block 530). For example, the controller may obtain, from a memory associated with the inference cache, one of the first attribute data or the second attribute data based on a request to generate an inference, as described above. In some implementations, process 500 may include utilizing the one of the first attribute data or the second attribute data to generate the inference. In some implementations, process 500 may include evicting, from the memory, at least one of the first attribute data or the second attribute data based on a least-recently-used algorithm, and storing third attribute data, for third attributes of a third trained machine learning model, in the memory to replace the first attribute data. The one of the first attribute data or the second attribute data may be obtained using the addresses of the first attribute data or the addresses of the second attribute data.

In some implementations, process 500 may include determining one or more cache sets, of the cache, to be used to store addresses of the third attribute data in the cache (block 535), and evicting, from the memory, the at least one of the first attribute data or the second attribute data based on the least-recently-used algorithm and based on a status the one or more cache sets (block 540).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving a request for an inference;
determining, based on the received request for the inference, a first inference model of a plurality of inference models, to generate the inference,
obtaining, from a memory associated with an inference cache, first attribute data regarding first attributes of the first inference model,
wherein a location of the first attribute data, in the memory, is determined using the inference cache, and
wherein the attributes include weights associated with the first inference model, biases associated with the first inference model, and a structure of the first inference model; and
utilizing the first attribute data to generate the inference based on the request.

2. The method of claim 1, wherein the inference cache includes a tag array for storing addresses of the attribute data and wherein the inference cache is associated with a data array for storing attribute data of inference models.

3. The method of claim 1, wherein the memory stores second attribute data regarding second attributes of a second inference model,
wherein the request is a first request and the inference is a first inference, and
wherein the method comprises:
receiving a second request for a second inference;
determining that the second inference is to be generated using a third inference model;
determining that third attribute data, for third attributes of the third inference model, is not stored in the memory;
determining that at least one of the first attribute data or the second attribute data is to be evicted from the memory based on determining that the third attribute data is not stored in the memory;
evicting the at least one of the first attribute data or the second attribute data from the memory; and
storing the third attribute data in the memory to replace the at least one of the first attribute data or the second attribute data.

4. The method of claim 3, wherein determining that the at least one of the first attribute data or the second attribute data is to be evicted from the memory comprises:
determining whether the third attribute data is to be stored in the memory based on a first single cache set or a first plurality of cache sets; and
determining whether the at least one of the first attribute data or the second attribute data are stored in the memory based on a second single cache set or a second plurality of cache sets.

5. The method of claim 4, comprising:
determining a size of the third attribute data; and
storing addresses of the third attribute data in the second plurality of cache sets based on the size of the third attribute data, wherein the inference cache includes information indicating that a cache set, of the second plurality of cache sets, is a first cache set of the second plurality of cache sets, and wherein the inference cache includes information indicating that one or more other cache sets, of the second plurality of cache sets, are included in the second plurality of cache sets.

6. The method of claim 4, comprising:
storing, prior to receiving the first request, addresses of the first attribute data and the second attribute data in the second single cache set or the second plurality of cache sets,
wherein the second plurality of cache sets are contiguous cache sets.

7. The method of claim 3, wherein determining that the at least one of the first attribute data or the second attribute data is to be evicted from the memory comprises:
determining that the at least one of the first attribute data or the second attribute data is to be evicted from the memory using a replacement algorithm,
wherein the replacement algorithm is based on a least-recently-used algorithm.

8. The method of claim 7, wherein determining that the at least one of the first attribute data or the second attribute data is to be evicted from the inference cache comprises:
determining a cache set, of the inference cache, that is to store addresses of the third attribute data prior to receiving the second request for the second inference, wherein the replacement algorithm is based on the least-recently-used algorithm.

9. A system comprising:
an inference cache;
a memory associated with the inference cache; and
a controller, associated with the inference cache, the controller to:
store first attribute data, regarding first attributes of a first machine learning model, in the memory,
wherein the first machine learning model is a first trained machine learning model;
store second attribute data, regarding second attributes of a second machine learning model, in the memory,
wherein the second machine learning model is a second trained machine learning model;
obtain, from the memory, one of the first attribute data or the second attribute data based on a request to generate an inference,
wherein a location of the one of the first attribute data or the second attribute data, in the memory, is determined using the inference cache; and
utilize the one of the first attribute data or the second attribute data to generate the inference.

10. The system of claim 9, wherein the controller is to:
determine a size of the first attribute data; and
store addresses of the first attribute data in multiple cache sets included in the one or more first cache sets based on the size of the first attribute data,
wherein the one or more first cache sets include contiguous cache sets.

11. The system of claim 10, wherein the controller is to:
determine that the size of the first attribute data exceeds a size of a range of addresses identified by a single cache set of the inference cache; and
store the addresses of the first attribute data in the multiple cache sets based on determining that the size of the first attribute data exceeds the size of the range of address.

12. The system of claim 11, wherein the inference cache is included in a random-access memory.

13. The system of claim 11, wherein the request is a first request and the inference is a first inference, and
wherein the controller is to:
receive a second request for a second inference;
determine that the second inference is to be generated using a third inference model;
determine that third attribute data, for third attributes of the third inference model, is not stored in the memory;
determine that at least one of the first attribute data or the second attribute data is to be evicted from the memory based on determining that the third attribute data is not stored in the memory;
evict the at least one of the first attribute data or the second attribute data from the memory; and
store the third attribute data in the memory to replace the at least one of the first attribute data or the second attribute data.

14. The system of claim 13, wherein, to determine that the at least one of the first attribute data or the second attribute data is to be evicted from the memory, the controller is to:
determine that the at least one of the first attribute data or the second attribute data is to be evicted from the memory using a least-recently-used algorithm.

15. The system of claim 13, wherein, to determine that the at least one of the first attribute data or the second attribute data is to be evicted from the inference cache, the controller is to:
prior to receiving the second request, determine a particular cache set, of the inference cache, that is to be evicted.

16. A computer program product comprising:
one or more computer readable storage media, and program instructions collectively stored on the one or more computer readable storage media, the program instructions comprising:
program instructions to store addresses of first attribute data, regarding first attributes of a first trained machine learning model, in an inference cache;
program instructions to store addresses of second attribute data, regarding second attributes of a second trained machine learning model, in the inference cache; and
program instructions to obtain, from a memory associated with the inference cache, one of the first attribute data or the second attribute data based on a request to generate an inference,
wherein the one of the first attribute data or the second attribute data is obtained using the addresses of the first attribute data or the addresses of the second attribute data.

17. The computer program product of claim 16, wherein the program instructions comprise:
program instructions to evict, from the memory, at least one of the first attribute data or the second attribute data based on a least-recently-used algorithm; and
program instructions to store third attribute data, for third attributes of a third trained machine learning model, in the memory to replace the first attribute data.

18. The computer program product of claim 17, wherein the program instructions comprise:
program instructions to determine one or more cache sets, of the inference cache, to be used to store addresses of the third attribute data in the inference cache; and
program instructions to evict, from the memory, the at least one of the first attribute data or the second attribute data based on the least-recently-used algorithm and based on the one or more cache sets.

19. The computer program product of claim 18, wherein the program instructions comprise:
program instructions to determine whether the addresses of the third attribute data are to be stored using a first single cache set or a first plurality of cache sets;
program instructions to determine whether addresses of the at least one of the first attribute data or the second attribute data are stored using a second single cache set or a second plurality of cache sets; and
program instructions to evict, from the memory, the at least one of the first attribute data or the second attribute data based on the least-recently-used algorithm, whether the addresses of the third attribute data is to be stored using the first single cache set or the first plurality of cache sets, and whether the addresses of the at least one of the first attribute data or the second attribute data is stored using the second single cache set or the second plurality of cache sets.

20. The computer program product of claim 17, wherein the program instructions comprise:
program instructions to utilize the one of the first attribute data or the second attribute data to generate the inference.
